(19) United States
(12) Patent Application Publication
(10) Pub. No.: US 2013/0266500 A1
(43) Pub. Date: Oct. 10, 2013

(54) SILICON OXIDE MATERIAL FOR NONAQUEOUS ELECTROLYTE SECONDARY BATTERY NEGATIVE ELECTRODE MATERIAL, MAKING METHOD, NEGATIVE ELECTRODE, LITHIUM ION SECONDARY BATTERY, AND ELECTROCHEMICAL CAPACITOR

(71) Applicant: SHIN-ETSU CHEMICAL CO., LTD., Tokyo (JP)

(72) Inventors: Hirofumi FUKUOKA, Annaka-shi (JP); Meguru KASHIDA, Annaka-shi (JP); Satoru MIYAWAKI, Annaka-shi (JP); Toshio OHBA, Annaka-shi (JP)

(21) Appl. No.: 13/903,623

(22) Filed: May 28, 2013

Related U.S. Application Data
(62) Division of application No. 13/103,173, filed on May 9, 2011.

(30) Foreign Application Priority Data
May 21, 2010 (JP) 2010-117188

(51) Int. Cl. H01M 4/134

(52) U.S. Cl. CPC H01M 4/134
USPC 423/325

(57) ABSTRACT

A silicon oxide material is obtained by cooling and precipitating a gaseous mixture of SiO gas and silicon-containing gas and has an oxygen content of 20-35 wt %. Using the silicon oxide material as a negative electrode active material, a nonaqueous electrolyte secondary battery is constructed that exhibits a high 1st cycle charge/discharge efficiency and improved cycle performance while maintaining the high battery capacity and low volume expansion of silicon oxide.

### CROSS-REFERENCE TO RELATED APPLICATION

This application is a Divisional of co-pending application Ser. No. 13/103,173, filed on May 9, 2011, which claims priority under 35 U.S.C. §119(a) on Patent Application No. 2010-117188 filed in Japan on May 21, 2010, the entire contents of which are hereby incorporated by reference and for which priority is claimed under 35 U.S.C. §120.

### TECHNICAL FIELD

This invention relates to a silicon oxide material and a method for preparing the same, the silicon oxide material being used as a negative electrode active material in lithium ion secondary batteries and electrochemical capacitors to construct a nonaqueous electrolyte secondary battery exhibiting a high 1st cycle charge/discharge efficiency and improved cycle performance. It also relates to a lithium ion secondary battery and electrochemical capacitor using a negative electrode material comprising the silicon oxide material.

### BACKGROUND ART

In conjunction with the recent rapid advances of portable electronic equipment and communications instruments, nonaqueous electrolyte secondary batteries having a high energy density are strongly demanded from the aspects of cost, size and weight reductions. Approaches known in the art to increase the capacity of such nonaqueous electrolyte secondary batteries include, for example, use as negative electrode material of oxides of B, Ti, V, Mn, Co, Fe, Ni, Cr, Nb, and Mo and composite oxides thereof (JP 3008228 and JP 3242751); application as negative electrode material of M₁₀₀₋ₓSiₓ wherein x≧50 at % and M=Ni, Fe, Co or Mn which is obtained by quenching from the melt (JP 3846661); use as negative electrode material of silicon oxide (JP 2997741); and use as negative electrode material of Si₂N₂O, Ge₂N₂O or Sn₂N₂O (JP 3918311).

Among others, silicon oxide is represented by SiOₓ wherein x is slightly greater than the theoretical value of 1 due to oxide coating, and is found on X-ray diffractometry analysis to have the structure that amorphous silicon ranging from several to several tens of nanometers is finely dispersed in silica. The silicon oxide particles are believed ready for use as the negative electrode active material because the battery capacity of silicon oxide is smaller than that of silicon, but greater than that of carbon by a factor of 5 or 6 on a weight basis, and the silicon oxide experiences a relatively less volume expansion.

Nevertheless, silicon oxide has a substantial irreversible capacity and a very low initial efficiency of about 70%, which requires an extra battery capacity of the positive electrode when a battery is actually fabricated. Then an increase of battery capacity corresponding to the 5 to 6-fold capacity increase per active material weight is not expectable.

The problem of silicon oxide to be overcome prior to practical use is a substantially low initial efficiency. This may be overcome by making up the irreversible fraction of capacity or by restraining the irreversible capacity. The method of making up the irreversible fraction of capacity by previously doping silicon oxide with Li metal is reported effective. Doping of lithium metal may be carried out by attaching a lithium foil to a surface of negative electrode active material (JP-A 11-086847) or by vapor depositing lithium on a surface of negative electrode active material (JP-A 2007-122992). As for the attachment of a lithium foil, a thin lithium foil that matches with the initial efficiency of silicon oxide negative electrode is hardly available or prohibitively expensive if available. The deposition of lithium vapor makes the fabrication process complex and is impractical.

Aside from lithium doping, it is also disclosed to enhance the initial efficiency of negative electrode by increasing a weight proportion of silicon. One method is by adding silicon particles to silicon oxide particles to reduce the weight proportion of silicon oxide (JP 3982230). In another method, silicon vapor is generated and precipitated in the same stage as is produced silicon oxide, obtaining mixed solids of silicon and silicon oxide (JP-A 2007-290919). Silicon has both a high initial efficiency and a high battery capacity as compared with silicon oxide, but displays a percent volume expansion as high as 400% upon charging. Even when silicon is added to a mixture of silicon oxide and carbonaceous material, the percent volume expansion of silicon oxide is not maintained, and eventually at least 20 wt % of carbonaceous material must be added in order to suppress the battery capacity at 1,000 mAh/g. The method of obtaining the mixed solids by simultaneously generating silicon and silicon oxide vapors suffers from the working problem that the low vapor pressure of silicon necessitates the process running at a high temperature in excess of 2,000° C.

### CITATION LIST

Patent Document 1: JP 3008228
Patent Document 2: JP 3242751
Patent Document 3: JP 3846661
Patent Document 4: JP 2997741
Patent Document 5: JP 3918311
Patent Document 6: JP-A H11-086847
Patent Document 7: JP-A 2007-122992
Patent Document 8: JP 3982230
Patent Document 9: JP-A 2007-290919

### SUMMARY OF INVENTION

As mentioned above, the siliceous active material has an outstanding problem independent of whether it is in metal form or oxide form. There is a need for a negative electrode active material which undergoes a minimized volume change upon occlusion and release of Li, which mitigates powdering due to fissure of particles and a drop of conductivity due to separation from the current collector, and which is amenable to mass scale production, cost effective, and viable in the application where repetitive cycle performance is of importance as in mobile phones.

An object of the invention is to provide a silicon oxide material serving as an active material to form a negative electrode material to construct a nonaqueous electrolyte secondary battery that exhibits a high 1st cycle charge/discharge efficiency and improved cycle performance while maintaining the high battery capacity and low volume expansion of silicon oxide, and a method for preparing the silicon oxide material. Another object is to provide a nonaqueous electrolyte secondary battery using a negative electrode comprising the silicon oxide material.

The inventors have found that a silicon oxide material which is obtained as a precipitate by cooling a gaseous mixture of SiO gas and silicon-containing gas for effecting precipitation or deposition and has an oxygen content of 20 to 35% by weight is useful as an active material for nonaqueous electrolyte secondary battery negative electrode material, and that a nonaqueous electrolyte secondary battery constructed using the same exhibits a high 1st cycle charge/discharge efficiency and improved cycle performance.

When a silicon oxide material which is a precipitate obtained by cooling a gaseous mixture of SiO gas and silicon-containing gas for precipitation and has an oxygen content of 20 to 35% by weight is used as a negative electrode material in a nonaqueous electrolyte secondary battery, specifically lithium ion secondary battery, the low oxygen content ensures that the amount of Li₄SiO₄ formed irreversibly upon charging is reduced, and a drop of the 1st cycle charge/discharge efficiency is suppressed as compared with that of the prior art. Therefore, the silicon oxide material constitutes a negative electrode material featuring a high 1st cycle charge/discharge efficiency and improved cycle performance while maintaining the high cell capacity and low volume expansion characteristic of silicon oxide.

Since the silicon oxide material is a precipitate obtained by cooling a gaseous mixture of SiO gas and silicon-containing gas for precipitation, the silicon oxide material has a composition that microcrystalline silicon is uniformly distributed within the silicon oxide material, as opposed to a mixture of silicon monoxide and silicon having a locally inconsistent composition. The uniform distribution ensures improved cycle performance.

Accordingly, the invention provides a silicon oxide material, a method for preparing the same, a nonaqueous electrolyte secondary battery negative electrode, a lithium ion secondary battery, and an electrochemical capacitor, as defined below.

In a first aspect, the invention provides a silicon oxide material for nonaqueous electrolyte secondary battery negative electrode material, which is obtained by cooling and precipitating a gaseous mixture of SiO gas and silicon-containing gas, and has an oxygen content of 20 to 35% by weight.

In a preferred embodiment, the silicon oxide material is in the form of particles having an average particle size of 0.1 to 30 μm and a BET specific surface area of 0.5 to 30 m²/g.

In a second aspect, the invention provides a negative electrode for use in nonaqueous electrolyte secondary batteries, comprising a negative electrode material comprising the silicon oxide material defined above.

In a third aspect, the invention provides a lithium ion secondary battery comprising the negative electrode defined above, a positive electrode, and a lithium ion-conductive nonaqueous electrolyte.

In a fourth aspect, the invention provides an electrochemical capacitor comprising the negative electrode defined above, a positive electrode, and a conductive electrolyte.

In a fifth aspect, the invention provides a method for preparing a silicon oxide material for nonaqueous electrolyte secondary battery negative electrode material, comprising the steps of heating a SiO gas-providing raw material at a temperature in the range of 1,100 to 1,600° C. in the presence of an inert gas or in vacuum to generate a SiO gas, adding a silicon-containing gas to the SiO gas to form a gaseous mixture, cooling the gaseous mixture for effecting precipitation or deposition, and recovering the precipitate. Typically, the SiO gas-providing raw material is a silicon oxide powder or a mixture of a silicon dioxide powder and a metal silicon powder.

### Advantageous Effects of Invention

The silicon oxide material serves as an active material to form a negative electrode material. A nonaqueous electrolyte secondary battery constructed using the same exhibits a high 1st cycle charge/discharge efficiency and improved cycle performance while maintaining the high battery capacity and low volume expansion of silicon oxide.

### BRIEF DESCRIPTION OF DRAWINGS

FIG. 1 schematically illustrates a horizontal tubular furnace used in the preparation of silicon oxide materials in Examples and Comparative Examples.

### DESCRIPTION OF EMBODIMENTS

### Silicon Oxide Material

The silicon oxide material of the invention is suited for use as a negative electrode material in nonaqueous electrolyte secondary batteries. The silicon oxide material is obtained by cooling and precipitating a gaseous mixture of SiO gas and silicon-containing gas and has an oxygen content of 20 to 35% by weight.

The oxygen content of the silicon oxide material is 20 to 35% by weight, preferably 23 to 33% by weight, and more preferably 25 to 32% by weight. When a silicon oxide material with an oxygen content of less than 20 wt % is used as a nonaqueous electrolyte secondary battery negative electrode material, some improvements in initial efficiency and cell capacity are observable, but a decline of cycle performance occurs as its composition approaches to silicon. If the oxygen content is more than 35 wt %, no improvements in initial efficiency and cell capacity are achievable. The oxygen content of the silicon oxide material may be measured by the oxygen-in-metal analysis method (inert gas fusion furnace oxygen analysis), for example. A typical analyzer is available as EMGA-920 from Horiba, Ltd.

The silicon oxide material is obtained as precipitate by cooling a gaseous mixture of SiO gas and silicon-containing gas for precipitation. Although a negative electrode material may be obtained by mixing silicon monoxide powder with silicon powder such that the overall mixture may have an oxygen content of 20 to 35 wt %, a secondary cell constructed using the same exhibits poor cycle performance. The method of preparing the silicon oxide material will be described later.

Although the physical properties of the silicon oxide material are not particularly limited, it preferably has an average particle size of 0.1 to 30 μm, more preferably 0.2 to 20 μm. Setting the average particle size of a silicon oxide material to at least 0.1 μm prevents the material from increasing its specific surface area to increase a proportion of silicon dioxide on particle surface. This concomitantly suppresses any reduction of a cell capacity when the material is used as a nonaqueous electrolyte secondary battery negative electrode material. The setting also prevents the material from reducing its bulk density and hence, prevents any drop of charge/discharge capacity per unit volume. In addition, such a silicon oxide material is easy to prepare and a negative electrode may be easily formed therefrom. Setting the average particle size of a silicon oxide material to at most 30 μm prevents the material from becoming foreign particles when coated on an electrode and adversely affecting cell properties. In addition, such a silicon oxide material is easy to prepare and the risk of separation from the current collector (e.g., copper foil) is minimized. It is noted that the average particle size as used herein is a particle diameter (median diameter) corresponding to a cumulative weight of 50% in particle size distribution measurement by laser light diffractometry.

The silicon oxide material should preferably have a BET specific surface area of 0.5 to 30 m²/g, more preferably 1 to 20 m²/g. As long as the BET specific surface area is at least 0.5 m²/g, the silicon oxide material is provided with a sufficient surface activity to prevent a binder from decreasing its bond strength during electrode fabrication which may result in degraded cell properties, and to avoid the risk of cycle performance being degraded by repeated charge/discharge cycles. A silicon oxide material with a BET specific surface area of up to 30 m²/g prevents a proportion of silicon dioxide on particle surface from increasing and concomitantly suppresses any reduction of a cell capacity when used as a lithium ion secondary battery negative electrode material. In addition, the material prevents the amount of solvent absorbed and the amount of binder consumed from increasing during electrode fabrication. It is noted that the BET specific surface area as used herein is a value measured by the BET single-point method of evaluating an amount of N₂ gas adsorbed.

### Method of Preparing Silicon Oxide Material

The silicon oxide material for use as nonaqueous electrolyte secondary battery negative electrode material is prepared by heating a SiO gas-providing raw material at a temperature in the range of 1,100 to 1,600° C. in the presence of an inert gas or in vacuum to generate a SiO gas, adding a silicon-containing gas to the SiO gas to form a gaseous mixture, cooling the gaseous mixture for effecting precipitation, and recovering the precipitate. The method of preparing a silicon oxide material is described below in detail although the method is not limited thereto.

The SiO gas-providing raw material is not particularly limited as long as it can generate SiO gas. The preferred raw material is a silicon oxide powder, typically silicon monoxide (SiO), or a mixture of a silicon dioxide powder and a reducing powder. Since the latter combination offers a high reactivity, SiO gas can be generated in high yields. Accordingly, a silicon oxide material can be prepared in high yields. Examples of the reducing powder include metal silicon compounds and carbon-containing powders. Inter alia, a metal silicon powder is preferably used because of higher reactivity and yield.

For a mixture of a silicon dioxide powder and a metal silicon powder used as the raw material, any suitable mixing ratio may be selected. However, the metal silicon powder and the silicon dioxide powder are preferably mixed in a ratio in the range: 1<metal silicon powder/silicon dioxide powder<1.1, and more preferably in the range: 1.01≦metal silicon powder/silicon dioxide powder≦1.08, when the presence of surface oxygen on the metal silicon powder and trace oxygen in the reactor furnace is taken into account.

The raw material is heated at a temperature in the range of 1,100 to 1,600° C., preferably 1,200 to 1,500° C. in the presence of an inert gas or in vacuum to generate a SiO gas. Unless heating is in an inert gas atmosphere or a reduced pressure thereof, the SiO gas generated may not remain stable, giving rise to the problem that the reaction efficiency of silicon oxide may lower, leading to reduced yields. The inert gas may be argon, helium or the like, and the vacuum is preferably 1 to 1,000 Pa. If the heating temperature is below 1,100° C., then the reaction proceeds, with difficulty, to generate only a small amount of SiO gas, resulting in a substantial drop of yield. If the heating temperature is above 1,600° C., then the raw material (powder or powder mixture) may be melted, losing reactivity, and hence, generating a reduced amount of SiO gas. In addition, the selection of a reactor furnace becomes difficult.

Next, a silicon-containing gas is added to the resulting SiO gas to form a gaseous mixture. The oxygen content of the silicon oxide material may be controlled in accordance with the type, flow rate and feed time of the silicon-containing gas. Specifically, the oxygen content may be controlled simply by adjusting the flow rate of the silicon-containing gas. For example, when monosilane gas is fed at a flow rate which is 1/10 of an hourly amount of SiO generated (which may be estimated from [(raw material charge)−(reaction residue)]/hour), a silicon oxide material having an oxygen content of about 32% may be produced.

The silicon-containing gas used herein is not particularly limited as long as the gas contains silicon. Examples of the silicon-containing gas include monosilane, dichlorosilane, trichlorosilane, silicon tetrachloride, silicon tetrafluoride, disilane, and tetramethylsilane, which may be used alone or in a combination of two or more. An inert non-oxidizing gas such as hydrogen, helium or argon may be used as a carrier gas in admixture with the silicon-containing gas. Of the silicon-containing gases, monosilane gas is most preferred because no by-products are formed and because of low cost.

The gaseous mixture is then cooled for precipitation. The precipitate is recovered as the silicon oxide material of the invention. The step of cooling the gaseous mixture for precipitation and recovering the precipitate is not particularly limited. One exemplary step is by introducing the gaseous mixture into a cooling zone where a precipitate is deposited on a precipitation substrate, or by spraying the gaseous mixture into a cooling atmosphere. Generally, the step of flowing the gaseous mixture through a cooling zone where a precipitate is deposited on a precipitation substrate is preferred.

The type and material of the precipitation substrate are not particularly limited. A substrate of a high-melting metal such as stainless steel, molybdenum or tungsten is preferred for ease of working. The cooling zone is preferably set at a precipitation temperature of 500 to 1,000° C., more preferably 700 to 950° C. A precipitation temperature of at least 500° C. makes it easy to prevent the reaction product from increasing its BET surface area beyond 30 m²/g. If the precipitation temperature is up to 1,000° C., any suitable material may be selected for the substrate and the precipitation apparatus may be of low cost. The temperature of the precipitation substrate may be controlled by heater power, thermal insulating properties (insulating wall thickness), forced cooling, or the like.

If necessary, the silicon oxide material deposited on the substrate may be ground to the desired particle size by any well-known grinding means.

To impart electroconductivity to the resulting silicon oxide material, carbon may be deposited thereon by chemical vapor deposition or mechanical alloying. When carbon coating is employed, the coverage (or coating weight) of carbon is preferably 1 to 50% by weight, more preferably 1 to 20% by weight based on the total weight of carbon-coated silicon oxide material.

The chemical vapor deposition of carbon may be conducted by introducing a hydrocarbon base compound gas and/or vapor into a deposition reactor chamber at a temperature in the range of 600 to 1,200° C., preferably 800 to 1,100° C. and under atmospheric or reduced pressure, where thermal chemical vapor deposition takes place in a well-known manner. It is also acceptable to form silicon composite particles in which a silicon carbide layer is formed at the silicon-carbon layer interface.

The hydrocarbon base compound used herein is thermally decomposed at the indicated temperature to form carbon. Examples of the hydrocarbon base compound include hydrocarbons such as methane, ethane, propane, butane, pentane, hexane, ethylene, propylene, butylene, and acetylene, alone or in admixture; alcohol compounds such as methanol and ethanol; mono- to tri-cyclic aromatic hydrocarbons such as benzene, toluene, xylene, styrene, ethylbenzene, diphenylmethane, naphthalene, phenol, cresol, nitrobenzene, chlorobenzene, indene, coumarone, pyridine, anthracene, and phenanthrene, alone or in admixture, and mixtures of the foregoing. Also, gas light oil, creosote oil and anthracene oil obtained from the tar distillation step are useful as well as naphtha cracked tar oil, alone or in admixture.

### Negative Electrode

A negative electrode may be prepared using a negative electrode material comprising the silicon oxide material of the invention. From the negative electrode material, a negative electrode (shaped form) may be prepared, for example, by the following procedure. The negative electrode is prepared by combining the silicon oxide material with a binder such as polyimide resin, an optional conductive agent and additives, kneading them in a solvent (suited for dissolution and dispersion of the binder) such as N-methylpyrrolidone or water to form a paste-like mix, and applying the mix in sheet form to a current collector.

The type of conductive agent used herein is not particularly limited as long as it is an electronically conductive material which does not undergo decomposition or alteration in the battery. Illustrative conductive agents include metals in powder or fiber form such as Al, Ti, Fe, Ni, Cu, Zn, Ag, Sn and Si, natural graphite, synthetic graphite, various coke powders, meso-phase carbon, vapor phase grown carbon fibers, pitch base carbon fibers, PAN base carbon fibers, and graphite obtained by firing various resins.

The current collector used herein may be a foil of any material which is commonly used as the negative electrode current collector, for example, a copper or nickel foil while the thickness and surface treatment thereof are not particularly limited. The method of shaping or molding the mix into a sheet is not particularly limited, and any well-known method may be used.

### Nonaqueous Electrolyte Secondary Battery

Using the thus obtained negative electrode (shaped form) in combination with a positive electrode and a nonaqueous electrolyte, a nonaqueous electrolyte secondary battery may be constructed. The nonaqueous electrolyte secondary battery is typically a lithium ion secondary battery in which the nonaqueous electrolyte is a lithium ion-conductive nonaqueous electrolyte. The nonaqueous electrolyte secondary battery is characterized by the use of the negative electrode material defined herein while the materials of the positive electrode, nonaqueous electrolyte, and separator and the battery design may be well-known ones and are not particularly limited.

For example, the positive electrode active material used herein may be selected from transition metal oxides such as LiCoO₂, LiNiO₂, LiMn₂O₄, V₂O₅, MnO₂, TiS₂ and MoS₂, and chalcogen compounds. The electrolytes used herein may be lithium salts such as lithium perchlorate in nonaqueous solution form. Examples of the nonaqueous solvent include propylene carbonate, ethylene carbonate, dimethoxyethane, γ-butyrolactone and 2-methyltetrahydrofuran, alone or in admixture. Use may also be made of other various nonaqueous electrolytes and solid electrolytes.

### Electrochemical Capacitor

Using the thus obtained negative electrode in combination with a positive electrode and a conductive electrolyte, an electrochemical capacitor may be constructed. The electrochemical capacitor is characterized by the electrode comprising the silicon oxide active material defined herein, while other materials such as electrolyte and separator and capacitor design are not particularly limited.

Examples of the electrolyte used herein include nonaqueous solutions of lithium salts such as lithium hexafluorophosphate, lithium perchlorate, lithium borofluoride, and lithium hexafluoroarsenate, and exemplary nonaqueous solvents include propylene carbonate, ethylene carbonate, dimethyl carbonate, diethyl carbonate, dimethoxyethane, γ-butyrolactone, and 2-methyltetrahydrofuran, alone or a combination of two or more. Other various nonaqueous electrolytes and solid electrolytes may also be used.

### EXAMPLE

Examples of the invention are given below by way of illustration and not by way of limitation.

### Example 1

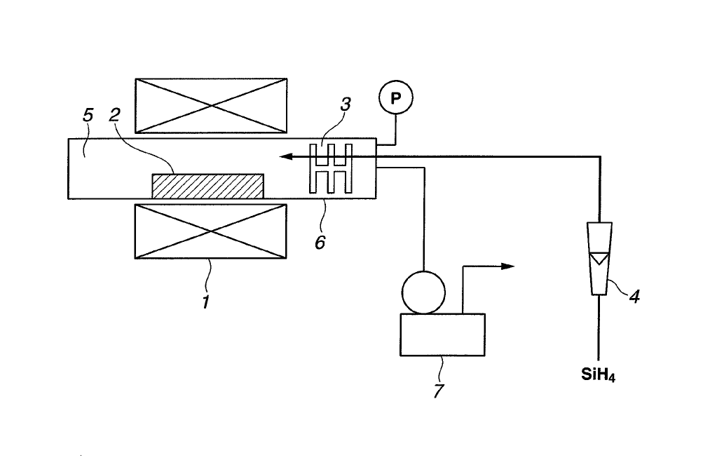

A silicon oxide material was prepared using a horizontal tubular furnace as shown in FIG. 1. Specifically, a reactor tube 6 of alumina having an inner diameter of 80 mm was charged with a raw material 2. The raw material was 50 g of a mixture of equimolar amounts of metal silicon powder having an average particle size of 5 μm and fumed silica powder having a BET surface area of 200 m²/g.

While a vacuum pump 7 was operated to evacuate the interior of the reactor tube 6 to a pressure of 20 Pa or below, a heater 1 was actuated to heat the reactor tube 6 to 1,400° C. at a rate of 300° C./hr. After the temperature of 1,400° C. was reached, monosilane (SiH₄) gas was fed into the reactor tube 6 at a flow rate of 0.2 NL/min through a flow meter 4 and a gas inlet tube whereby the interior pressure rose to 25 Pa. This operation was continued for 2 hours, after which the silane gas flow and heating were stopped. The reactor tube was allowed to cool to room temperature.

After cooling, the precipitate deposited on a precipitation substrate 3 was recovered, which was found to be a black mass and weigh 33 g. The precipitate, 30 g, was dry milled in a 2-L alumina ball mill, yielding a silicon oxide powder. The silicon oxide powder was measured for average particle size and BET specific surface area, with the results shown in Table 1.

Cell Test

The thus obtained silicon oxide powder was processed in the following way. Using the powder as a negative electrode active material, a test cell was constructed.

To the silicon oxide powder were added 45% by weight of synthetic graphite (average particle size 10 μm) and 10% by weight of polyimide. Then N-methylpyrrolidone was added to the mixture to form a slurry. The slurry was coated onto a copper foil of 12 μm thick and dried at 80° C. for one hour. Using a roller press, the coated foil was shaped under pressure into an electrode sheet. The electrode sheet was vacuum dried at 350° C. for 1 hour, after which pieces of 2 cm² were punched out as the negative electrode. The negative electrode had a thickness of 42 μm inclusive of the copper foil.

To evaluate the charge/discharge characteristics of the piece as the negative electrode, a test lithium ion secondary cell was constructed using a lithium foil as the counter electrode. The electrolyte solution used was a nonaqueous electrolyte solution of lithium hexafluorophosphate in a 1/1 (by volume) mixture of ethylene carbonate and diethyl carbonate in a concentration of 1 mol/liter. The separator used was a porous polyethylene film of 30 μm thick.

The lithium ion secondary cell thus constructed was allowed to stand overnight at room temperature. Using a secondary cell charge/discharge tester (Nagano K.K.), a charge/discharge test was carried out on the cell. Charging was conducted with a constant current flow of 0.5 mA/cm² until the voltage of the test cell reached 0 V, and after reaching 0 V, continued with a reduced current flow so that the cell voltage was kept at 0 V, and terminated when the current flow decreased below 40 μA/cm². Discharging was conducted with a constant current flow of 0.5 mA/cm² and terminated when the cell voltage exceeded 2.0 V, from which a discharge capacity was determined. By repeating the above operation, the charge/discharge test was carried out 50 cycles on the lithium ion secondary cell. A discharge capacity after 50 cycles was determined. The results of the cell test are tabulated in Table 1.

### Example 2

A silicon oxide material for nonaqueous electrolyte secondary battery negative electrode material was prepared by the same procedure as in Example 1 except that SiH₄ gas was fed at a flow rate of 0.3 NL/min. As in Example 1, the physical properties and cell properties of the silicon oxide material were evaluated, with the results shown in Table 1.

### Example 3

A silicon oxide material for nonaqueous electrolyte secondary battery negative electrode material was prepared by the same procedure as in Example 1 except that SiH₄ gas was fed at a flow rate of 0.1 NL/min. As in Example 1, the physical properties and cell properties of the silicon oxide material were evaluated, with the results shown in Table 1.

### Comparative Example 1

A silicon oxide material for nonaqueous electrolyte secondary battery negative electrode material was prepared by the same procedure as in Example 1 except that no SiH₄ gas was fed. As in Example 1, the physical properties and cell properties of the silicon oxide material were evaluated, with the results shown in Table 1.

### Comparative Example 2

A silicon oxide material for nonaqueous electrolyte secondary battery negative electrode material was prepared by the same procedure as in Example 1 except that SiH₄ gas was fed at a flow rate of 0.5 NL/min. As in Example 1, the physical properties and cell properties of the silicon oxide material were evaluated, with the results shown in Table 1.

### Comparative Example 3

A silicon oxide material was obtained by mixing SiO powder having an average particle size of 5 μm with Si powder in a SiO/Si ratio of 2/1. It was used as negative electrode material. As in Example 1, the physical properties and cell properties of the silicon oxide material were evaluated, with the results shown in Table 1.

TABLE 1

| | | Physical properties of | | | 1st cycle | | | 50th cycle | |
|---|---|---|---|---|---|---|---|---|---|
| | | silicon oxide material | | | cell properties | | | cell properties | |
| | | Average | BET | Oxygen | Charging | Discharging | Charge/ | Discharging | Cycle |
| | | particle | surface | content | capacity | capacity | discharge | capacity | retentivity |
| | | size (μm) | area (m²/g) | (wt %) | (mAh/g) | (mAh/g) | efficiency (%) | (mAh/g) | (%) |
| Example | 1 | 5.3 | 5.3 | 26.8 | 1,450 | 1,210 | 83.4 | 1,160 | 96 |
| | 2 | 5.3 | 4.7 | 21.8 | 1,520 | 1,290 | 84.9 | 1,210 | 94 |
| | 3 | 5.2 | 5.8 | 32.6 | 1,330 | 1,060 | 80.0 | 1,040 | 98 |
| Comparative | 1 | 5.3 | 6.3 | 35.8 | 1,310 | 1,000 | 76.3 | 980 | 98 |
| Example | 2 | 5.3 | 4.1 | 17.2 | 1,570 | 1,380 | 87.9 | 1,190 | 86 |
| | 3 | 5.1 | 5.3 | 24.8 | 1,500 | 1,290 | 86.0 | 760 | 59 |

As seen from Table 1, the silicon oxide material for nonaqueous electrolyte secondary battery negative electrode material obtained in Example 1 was a powder having an average particle size of 5.3 μm, a BET surface area of 5.3 m²/g, and an oxygen content of 26.8 wt %. The silicon oxide material in Example 2 was a powder having an average particle size of 5.3 μm, a BET surface area of 4.7 m²/g, and an oxygen content of 21.8 wt %. The silicon oxide material in Example 3 was a powder having an average particle size of 5.2 μm, a BET surface area of 5.8 m²/g, and an oxygen content of 32.6 wt %.

In contrast, the silicon oxide material in Comparative Example 1 was a powder having an average particle size of 5.3 μm, a BET surface area of 6.3 m²/g, and an oxygen content of 35.8 wt %. The silicon oxide material in Comparative Example 2 was a powder having an average particle size of 5.3 μm, a BET surface area of 4.1 m²/g, and an oxygen content of 17.2 wt %. The silicon oxide material in Comparative Example 3 was a powder having an average particle size of 5.1 μm, a BET surface area of 5.3 m²/g, and an oxygen content of 24.8 wt %.

Also as seen from Table 1, the lithium ion secondary cell using a negative electrode made of the negative electrode material comprising the silicon oxide material of Example 1 exhibited a 1st cycle charging capacity of 1,450 mAh/g, a 1st cycle discharging capacity of 1,210 mAh/g, a 1st cycle charge/discharge efficiency of 83.4%, a 50th cycle discharging capacity of 1,160 mAh/g, and a post-50th cycle retentivity of 96%, indicating a lithium ion secondary cell having a high capacity as well as improved 1st cycle charge/discharge efficiency and cycle performance.

The lithium ion secondary cell using the silicon oxide material of Example 2 exhibited a 1st cycle charging capacity of 1,520 mAh/g, a 1st cycle discharging capacity of 1,290 mAh/g, a 1st cycle charge/discharge efficiency of 84.9%, a 50th cycle discharging capacity of 1,210 mAh/g, and a post-50th cycle retentivity of 94%, indicating a lithium ion secondary cell having a high capacity as well as improved 1st cycle charge/discharge efficiency and cycle performance.

The lithium ion secondary cell using the silicon oxide material of Example 3 exhibited a 1st cycle charging capacity of 1,330 mAh/g, a 1st cycle discharging capacity of 1,060 mAh/g, a 1st cycle charge/discharge efficiency of 80.0%, a 50th cycle discharging capacity of 1,040 mAh/g, and a post-50th cycle retentivity of 98%, indicating a lithium ion secondary cell having a high capacity as well as improved 1st cycle charge/discharge efficiency and cycle performance.

In contrast, the lithium ion secondary cell using the silicon oxide material of Comparative Example 1 exhibited a 1st cycle charging capacity of 1,310 mAh/g, a 1st cycle discharging capacity of 1,000 mAh/g, a 1st cycle charge/discharge efficiency of 76.3%, a 50th cycle discharging capacity of 980 mAh/g, and a post-50th cycle retentivity of 98%, indicating a lithium ion secondary cell having better cycle performance, but apparently inferior 1st cycle charge/discharge efficiency due to a high oxygen content, as compared with the silicon oxide materials of Examples 1 to 3.

The lithium ion secondary cell using the silicon oxide material of Comparative Example 2 exhibited a 1st cycle charging capacity of 1,570 mAh/g, a 1st cycle discharging capacity of 1,380 mAh/g, a 1st cycle charge/discharge efficiency of 87.9%, a 50th cycle discharging capacity of 1,190 mAh/g, and a post-50th cycle retentivity of 86%, indicating a lithium ion secondary cell having apparently inferior cycle performance due to a low oxygen content, as compared with the silicon oxide materials of Examples 1 to 3.

The lithium ion secondary cell using the silicon oxide material of Comparative Example 3 exhibited a 1st cycle charging capacity of 1,500 mAh/g, a 1st cycle discharging capacity of 1,290 mAh/g, a 1st cycle charge/discharge efficiency of 86.0%, a 50th cycle discharging capacity of 760 mAh/g, and a post-50th cycle retentivity of 59%, indicating a lithium ion secondary cell having apparently inferior cycle performance despite an equivalent oxygen content, as compared with the silicon oxide materials of Examples 1 to 3. The reason is that the silicon oxide material of Comparative Example 3 had a locally inconsistent composition since it was prepared simply by mixing SiO powder with Si powder rather than by reacting SiO gas with silicon-containing gas as in Examples 1 to 3.

Japanese Patent Application No. 2010-117188 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method for preparing a silicon oxide material for nonaqueous electrolyte secondary battery negative electrode material, comprising the steps of:
heating a SiO gas-providing raw material at a temperature in the range of 1,100 to 1,600° C. in the presence of an inert gas or in vacuum to generate a SiO gas,
adding a silicon-containing gas to the SiO gas to form a gaseous mixture,
cooling and precipitating the gaseous mixture, and
recovering the precipitate.

2. The method of claim 1 wherein the SiO gas-providing raw material is a silicon oxide powder or a mixture of a silicon dioxide powder and a metal silicon powder.
